(19) United States
(12) Patent Application Publication
(10) Pub. No.: US 2006/0229203 A1
(43) Pub. Date: Oct. 12, 2006

(54) Coated seed and method for coating seeds

(75) Inventors: Jari Peltonen, Lahela (FI); Reijo Aksela, Espoo (FI); Anders Weckman, Espoo (FI)

Correspondence Address: BIRCH STEWART KOLASCH & BIRCH, PO BOX 747, FALLS CHURCH, VA, 22040-0747, US

(73) Assignee: Kemira GrowHow Oyj, Helsinki (FI)

(21) Appl. No.: 10/560,234

(22) PCT Filed: Jun. 3, 2004
(86) PCT No.: PCT/FI04/00340

§ 371 Date: Apr. 20, 2006

(30) Foreign Application Priority Data
Jun. 13, 2003 (FI) 20030896

(51) Int. Cl. A01N 25/26

(52) U.S. Cl. 504/100

(57) ABSTRACT

The present invention relates to coated plant seeds, comprising seeds coated with at least one fixing agent comprising an asparatic acid derivative, and with at least one plant nutrient. The present invention is further directed to a method for coating seeds, and a coating composition.

The present invention relates to coated plant seeds, and a coating composition therefor comprising an fixing agent and a plant nutrient, as well as to a method for coating seeds.

Coating of plant seeds for various reasons has been known in prior art for a long time. There are various coating treatments, starting from the simple and traditional dressing of crop seeds with pesticides for controlling plant diseases and pests. In this case, intact seeds are treated with an active agent in finely divided powder form or with a powder mixture containing such an active agent, or with said active agent dissolved or slurried in a suitable solvent, often in water or an organic solvent, followed by the treatment of the seed with the solution or slurry thus obtained.

Especially the applicability of various polymers has been studied. It is for instance known to coat seeds with water-soluble polymers, e.g. with starch, carboxymethyl cellulose or gum arabicum. The main drawback is the high amount of water relating the use thereof. Special equipment is needed for handling high water amounts, and further, this coating process is slow. It is often necessary to dry the seeds coated with this technique at low temperatures to prevent seed damages. Said polymers often form a hard, fragile coating around the seeds.

Coating of seeds is also used to delay the germination thereof (EP 1238714, Landec Corp; U.S. Pat. No. 6,230,438, Grow Tec Inc.). Polymers are also used as fixing agents to coat seeds with agents having various activities. Such coating may for instance improve the resistance of the seeds to aridity, heat, salty soil, or to other external stress factors. With coatings, for instance light rice seeds are made heavier, thus preventing them from being easily entrained with water or wind; see for instance U.S. Pat. No. 4,192,095. It is also commonly known to add nutrients to said coating for promoting plant growth.

One of the problems have been the poor germination of the seeds and the poor adherence of the nutrients on the seed surfaces in cases where particularly oil and aqueous solutions are used as fixing agents, respectively. Intensive research activities are performed to solve these problems. Various fixing agent compositions have been tested for adhering nutrients or other agents promoting plant growth on the plant seed surfaces.

Time, within which plant roots reach a fertilizer, plays a major role in the ability of the plant to utilize the nutrients of the fertilizer and to grow and develop during the first few weeks.

The amounts of main nutrients (N, K, P, Ca, S, Mg) being transferred from fertilizers to plants, that is the nutrient efficiency, normally varies from a few percent to 70-80 percent. Particularly, the efficiency of phosphorus is low, being from 5 to 20%. The efficiencies of trace nutrients (B, Co, Cu, Fe, Mn, Mo, Zn, Cl) are often even lower.

The route of application of the fertilizer, that is the distance between the fertilizer and the seed, has an effect on the ability of the plant to use the nutrients. The nutrients of the fertilizer applied too far away from the seed, say for instance at a distance of 6 cm therefrom, may have time to react with the salts or ions in the soil to form poorly soluble compounds well before the roots of the plant have reached the application point of the fertilizer.

Root development is an important step in the initial evolution of the plant. Well-developed roots may later effectively utilize nutrients bound to soil particles. For the development of the roots, phosphorus is necessary, and accordingly, the closer the phosphorus lies to the seeds, the easier it may be taken up.

In cases where phosphorus fertilizer is for instance applied in a traditional dispersed manner on the whole soil surface or mixed with the superficial soil layer, the phosphorus efficiency is from 5 to 10%. On the contrary, if the fertilizer is applied to rows or as bands at a given distance from the seeds, the phosphorus efficiency will be about 10%.

Phosphorus efficiency is somewhat improved by applying the phosphorus fertilizer adjacent to the seeds, or by coating the seeds with the fertilizer. In these cases the efficiencies are respectively 15 and 20%.

WO 9325078 discloses a composition used to coat seeds, comprising a hydrolyzate of a polysaccharide, for instance a hydrozylate of carboxymethyl cellulose or a carboxymethyl starch. Aqueous solutions of said agents may be sprayed in rather concentrated form (30%) on the seeds.

U.S. Pat. No. 5,661,103 discloses a seed coating promoting plant development, said coating comprising polymeric organic acid such as polyaspartic acid having a molecular weight of above 1500. According to this document, the molecular weight of the polyorganic acid should be sufficiently high, said acid preferably being non-chelating. Also EP 1036492 describes a seed coating that promotes plant development, said coating consisting of a film-forming cross-linked proteinaceous material and other active ingredients including pesticides and/or plant nutrients.

Generally, the use of polymers insoluble in water requires the use of organic solvents, in which case high solvent amounts promote the penetration of the polymer into the seed. Aqueous suspensions of these polymers may also be used for treating the seeds. For instance CA PLUS 112:17756 (PL 146138) and CA PLUS 122:49097 (PL 159474) present such applications.

Document U.S. Pat. No. 4,251,952 presents seeds coated with a mixture of sugar and a polymer insoluble in water. Various commercially available polymers or copolymers are used as polymers.

One of the drawbacks of prior art methods may be the tackiness of the surfaces of the coated seeds, causing the seeds to stick to each other, thus impairing the flowability thereof. Also the equipment necessary for the treatment of the seeds are easily fouled. Moreover, a coating with high moisture content may cause premature germination of the seeds.

A seed coating consisting of two components is known from WO 0145489 of the present applicant, the first component of the coating comprising an aqueous fixing agent containing a liquid by-product from agriculture or fermentation, especially molasses, and an emulgated oil, the other component comprising a fertilizer in powder form. In this publication, said technique is called iSeed seed treatment, or iSeed method. A seed coating in emulsion or emulsion suspension form is also presented in the non-published application FI 2002 2089 of the present applicant.

FI 2001 1328 of the present applicant discloses a fertilizer and an amount thereof optimal for various plants providing in combination with an aqueous fixing agent an optimal interaction between sprouting percentage and phosphorus uptake.

Even though the growth results in field trials have been satisfactory, the utilization of phosphorus is more efficient and the total need for phosphorus fertilization has been decreased, but however, some practical problems still arise.

Need to sufficiently comminute the fertilizer starting material has been a problem. Moreover, comminution itself is an additional and problematic process step. All salts may not be comminuted for instance due to the hygroscopicity thereof or bound water therein. Further, finely divided fertilizer powders produce dust. Part of the fertilizer may also be peeled off the seed surfaces due to abrasion of the seeds against each other in case of an uneven comminution and/or if the particles are too large in size.

In addition of the said disadvantages, considerable differences between plant species have been found when coating seeds with fertilizers (Scott, J. M. 1989, Seed coating and treatments and their effects on plant establishment, Advances in Agronomy, 42:43-83). It is generally acknowledged that the phytotoxic effect of fertilizer salts lowering germination is caused by ionic toxicity. For instance among crop plants, oats is more resistant to fertilizer salts than wheat in case of seed coating. Difference in seed structure has been found to be a reason to this. In oats, the seed germ is protected by trichomes and hairy projections whereas wheat is a species with naked seeds. Accordingly, crop plants are in general more resistant to coating of the seeds with fertilizers than are the seeds of leguminous plants. In other words, the components of the husk itself provide a great protection against the effects of fertilizer salts in case of some species.

It is generally accepted in the art that among different plant species, the phytotoxic effects of fertilizer salts are more apparent in countries suffering from drought stress. In case of sensitive species, attempts are made to eliminate the adverse interaction between the sensibility of the species and the drought stress of the soil by adding an artificial protective layer prior to the actual fertilizer coating of the seeds. For instance sugars (e.g. saccharose) or polyvinyl acetate are used as such protective agents. However, the use of said agents in practical coating processes has not proven suitable. It is also possible to reduce phytotoxic effects by selecting proper fertilizer salts and controlling the pH value of the salts, but, particularly if solubilities of the nutrients are decreased, this may lead to a loss of activity of the actual fertilizer coating.

### BRIEF DESCRIPTION OF THE INVENTION

The present invention relates to coated seeds and to a method for coating seeds. With the invention, particularly favourable results are obtained for coating seeds of species with naked seeds.

Further, the invention is directed to a coating comprising a fixing agent that forms complexes with metals and a trace element and/or a nutrient salt.

### DETAILED DESCRIPTION OF THE INVENTION

Characteristic features of the invention are presented in claims 1-9.

Accordingly, the invention provides a coated plant seed coated with at least one fixing agent comprising at least one aspartic acid derivative, and at least with one plant nutrient. The invention is further directed to a coating composition, to a method for coating seeds, and to an aqueous coating composition for coating seeds.

According to the invention, the adverse interaction of the sensitivity of the plant species and cultivation conditions for seed coating with plant nutrients may succesfully be decreased by using as a fixing agent at least one aspartic acid derivative having a molecular weight preferably less than 500. The aspartic acid derivative to be used as the fixing agent is particularly preferably a chelating agent being able to form a complex with metals, for instance with a plant nutrient metal. Compounds that may suitably be used as such chelating fixing agents include known agents for complexing metals that degrade in nature.

Complexing agents of the invention suitable for coating include ethylenediamine disuccinic acid (EDDS), iminodisuccinic acid (ISA), any further polyaspartic acid suitable as fixing agent having a molecular weight less than 500, isomers and salts thereof, preferably alkali and alkaline earth metal salts thereof. According to a particularly preferable embodiment of the invention, the fixing agent is selected from the group consisting of ethylenediamine disuccinic acid (EDDS), iminodisuccinic acid (ISA), isomers thereof and salts thereof, preferably alkali and alkaline earth metal salts thereof.

According to the invention, it is possible to use several fixing agent compounds, at least one of which is a fixing agent of the invention, depending on the sensitivity of the plant species and cultivation conditions. Moreover, it is possible to use for instance two or several different fixing agents of the invention. Furthermore, seeds may be coated with one or more trace element(s) and/or nutrient salt(s).

The use of the fixing agents of the invention improves considerably the adherence of trace elements/nutrient salts on seeds without lowering the germination thereof, even the germination of species having naked seeds is not lowered.

The coating composition is preferably prepared by slurrying the trace element and/or the nutrient salt into an aqueous fixing agent solution. The nutrient salt dissolved in the aqueous phase contributes to uniform distribution of the trace element and/or the nutrient in the coating.

Plant nutrient components may include any essential inorganic ions (primary, secondary and trace elements), as well as organic compounds releasing plant nutrients such as urea or methylurea. The plant nutrient component may be a so-called main nutrient salt comprising for instance N, K and/or P ions, a so-called secondary nutrient comprising Ca, S and/or Mg ions, or a trace mineral comprising Fe, Mn, Zn, Cu, Mo, Cl, B and/or Co ions.

Said nutrient salts preferably contain phosphates. The phospate may consist of a single or several phosphate salts, e.g. monosodium, monopotassium, or monoammonium phosphate. A similar nutrient mixture may also be composed of phosphoric acid and various bases. The phosphoric acid may be any concentrated phosphoric acid, particularly fluorine-depleated fertilizer grade fodder acid (so-called Profo acid). Bases may include oxides, hydoxides or carbonates or mixtures thereof, e.g. KOH, NaOH, K₂CO₃, Na₂CO₃, NH₃, CaO, MgO, CaCO₃, CaMg(CO₃)₂.

The coating composition may also contain other conventional ingredients including pesticides, growth regulators such as compounds and/or microbes stimulating growth, preservatives, stabilizers and/or functional agents like selenium. In addition, the coating composition may contain sugar.

For coating seeds, the amount of the fixing agent compound is preferably 0.01-5%, more preferably 0.03-5%, particularly preferably 0.1-5% by weight, relative to seed weight. For coating seeds, for instance 0.1-3% by weight of the fixing agent compound may be used. Further, for coating seeds, 0.1-2% by weight of a trace element, 0.1-10% by weight of a nutrient salt, 0-2% by weight of a further agent having an effect on plant growth, and 0.1-10% by weight of water, based on seed weight, may be used.

Moreover, the invention provides an aqueous coating composition for coating seeds. According to a particular embodiment, said aqueous coating composition contains 1-50%, preferably 5-50%, more preferably 5-30% by weight of the fixing agent, 0-15% by weight of a trace element, 0-70%, preferably 0-40% by weight of a nutrient salt, 0-15% by weight of any compounds having an effect on plant growth, and 30-90% by weight of water. However, depending on the embodiment, it is also possible to use an aqueous coating composition that is more or less concentrated with respect to one or several of said ingredients, for instance with respect to the fixing agent and nutrient salts. Thus, said aqueous coating composition may also contain 10-30% by weight of the fixing agent, 0-15% by weight of a trace element, 0-40% by weight of a nutrient salt, 0-15% by weight of further compounds having an effect on plant growth, and 30-90% by weight of water.

Unless otherwise specified, the contents of trace elements and nutrient salts are based on weights without bound water.

According to the invention, the method for coating seeds is carried out as follows. The seeds to be coated are subjected to an apparatus suitable for treating seeds, followed by the addition of the fixing agent and/or trace elements/nutrient salts in the form of an aqueous solution to form a coating on the seeds. In this case the coating is performed in a single stage. An alternative embodiment of the invention is a so-called double step coating method wherein the seeds are first coated with an aqueous solution of the fixing agent, or with an aqueous solution containing the fixing agent and trace elements/nutrient salts, followed by coating with nutrient salts in solid powder form.

One way to coat seeds is to fill a rotating drum therewith, followed by spraying the aqueous solution of the fixing agent and trace elements/nutrient salts on the seeds while mixing, then maintaining mixing to assure a uniform coating result. The seeds may finally be dried with an air stream.

It is also possible to coat the seeds by spraying an aqueous solution of the fixing agent or an aqueous solution of the fixing agent and the trace elements/nutrient salts on the seeds in the drum to form an fixing agent coating on the seeds, followed by the addition of the nutrient salt powder over the fixing agent coating. The size and surface quality of the seeds to be coated determine the amount of the fixing agent necessary to bind the desired amount of the trace elements/nutrient salts on the seeds.

With said method, preferably coated plant seeds of the invention are prepared. Further, the aqueous coating composition used in the method is preferably an aqueous coating composition of the invention.

If it is desirable to treat the seeds also with pesticides, growth regulators such as compounds and/or microbes stimulating growth, preservatives, stabilizers, and/or functional agents like selenium, the addition of the agents soluble in water may be performed simultaneously with the fixing agent, whereas the addition of the agents in powder form may take place prior to or after or simultaneously with the addition of the nutrient salt powder.

Suitable composition and the amount thereof to be applied depend on the size and surface quality of the seeds to be coated, these being characteristics features for each plant species.

Solutions Provided by the Invention to Presented Problems

The use of biodegradable compounds as fixing agents for coating seeds provides strong adherence of trace elements and nutrient salts. Detachment of the nutrients from the seeds is reduced since there are no separate particles of the trace elements/nutrient salts on the seed surface. Possible problems of “burns” caused by salts are also eliminated since the nutrient salts no longer accumulate on sensitive seed surfaces.

Metal complexing acitivity of the fixing agent used as seed coating alone intensifies the initial development of the seeds due to the fact that they may effectively utilize even nutrients bound to soil.

The invention allows for a more flexible addition of nutrients in seed coatings. The composition is not limited to any starting materials since also acid and base components may be added. Moreover, the composition is less expensive due to the fact that instead of nutrient salts, the raw materials thereof may be used.

After germination, the coated seed provides the roots with necessary trace elements and phosphorus. Phosphorus on the seed assures the important initial development of the plant clearly better that a fertilizer applied broadly on the soil, also more efficiently than a starter applied in the seed row. Superior efficiency of the nutrients is very preferable for the farmer and for the environment since excessive loading thereof with nutrients is avoided. After a favourable initial development, the plant may also effectively utilize nutrients already bound to the soil.

### EXAMPLES

Unless otherwise specified, nutrient analyses were performed in a known manner using X-ray fluorescence, and if necessary, with solution analysis.

Dry matter assays of the biomass were carried out by cutting the aerial plant parts and weighing them after drying for 24 hours at 60° C.

### Example 1

Coating of Corn with ISA and Na-Phosphate

A corn variety (Jet) was coated with 0.4% of P by using a solution containing Na-ISA, sodium phosphate and sugar. In a comparative trial, a corresponding amount of phosphorus (0.4%) was used, but a paste consisting of 50% of monopotassium phosphate powder and 50% of fixing agent served as the coating. The fixing agent contained 50% of mixed molasses, 10% of mineral oil, 3.1% of an emulgator, 0.6% of a stabilizer, and 36.3% of water (=MKP paste). Recipes are shown in Table 1. In pot trials, also uncoated seeds were used as controls. In Table 2, dry weights after 18 days, percent germination, nutrient analyses of the dry matter (mean values of three parallel tests with standard deviation, STD) are shown. Relative nutrient uptake in comparison with controls is presented in Table 3.

From the results it may be seen, that the germination ability is unchanged, phosphorus uptake is improved as is the uptake of the trace elements (Mg, Fe, Cu, Zn, Mn) owing to the chelate.

TABLE 1
Coating composition

| | Corn | NaH₂PO₄ | | 34-% | | Fixing | | | | |
|---|---|---|---|---|---|---|---|---|---|---|
| | seeds, | *H₂O | KH₂PO₄ | Na-ISA | Sugar, | agent, | Water, | N, | P, | K, |
| | g | g | g | g | g | g | g | g | g | g |
| ISA + | 400 | 20 | 0 | 30 | 5 | 0 | 0.5 | 0.4 | 4.5 | 0 |
| Na-phosphate | | | | | | | | | | |
| MKP paste | 100 | 0 | 1.75 | 0 | 0 | 1.75 | 0 | 0 | 0.9 | 0.5 |

TABLE 2
Germination and dry matter analyses of the biomass

| | Control, no | Control, | ISA + Na- | ISA + Na- | | MKP paste, |
|---|---|---|---|---|---|---|
| | coating | STD | phosphate | phosphate, STD | MKP paste | STD |
| Germination, % | 98 | | 99 | | 89 | |
| Dry weight of | 5.7 | | 5.7 | | 5.2 | |
| biomass, g | | | | | | |
| K, % | 1.88 | 0.015 | 2.07 | 0.017 | 2.81 | 0.006 |
| P, % | 0.63 | 0.014 | 0.68 | 0.004 | 0.66 | 0.005 |
| Ca, % | 0.94 | 0.009 | 0.84 | 0.011 | 0.78 | 0.001 |
| Mg, % | 0.45 | 0.005 | 0.50 | 0.006 | 0.42 | 0.019 |
| Cl, % | 0.60 | 0.004 | 0.62 | 0.006 | 0.68 | 0.009 |
| Si, % | 0.18 | 0.005 | 0.21 | 0.01 | 0.24 | 0.009 |
| S, % | 0.39 | 0.003 | 0.41 | 0.005 | 0.42 | 0.006 |
| Fe, ppm | 103 | 1.7 | 115 | 1.5 | 114 | 1.2 |
| Mn, ppm | 64 | 0.0 | 64 | 2.6 | 54 | 3.1 |
| Zn, ppm | 39 | 1.0 | 45 | 1.5 | 44 | 1.2 |
| Cu, ppm | 7 | 1.3 | 9 | 0.5 | 8 | 1.0 |

TABLE 3
Uptake of nutrients compared to control

| | Control, no | Control, | ISA + Na- | %, compared to | | %, compared |
|---|---|---|---|---|---|---|
| | coating | STD | phosphate | control | MKP paste | to control |
| Germination, % | 98 | 100 | 99 | 101 | 89 | 91 |
| Dry weight of | 5.7 | 100 | 5.7 | 100 | 5.2 | 91 |
| biomass, g | | | | | | |
| K, mg | 107 | 100 | 118 | 110 | 146 | 136 |
| P, mg | 35.9 | 100 | 38.8 | 108 | 34.2 | 95 |
| Ca, mg | 53.8 | 100 | 48.1 | 89 | 40.6 | 76 |
| Mg, mg | 25.7 | 100 | 28.8 | 112 | 21.8 | 85 |
| Cl, mg | 34.4 | 100 | 35.4 | 103 | 35.4 | 103 |
| Si, mg | 10.1 | 100 | 11.9 | 118 | 12.7 | 125 |
| S, mg | 22.1 | 100 | 23.4 | 106 | 21.8 | 99 |
| Fe, mg | 0.587 | 100 | 0.654 | 111 | 0.591 | 101 |
| Mn, mg | 0.365 | 100 | 0.365 | 100 | 0.283 | 77 |
| Zn, mg | 0.222 | 100 | 0.258 | 116 | 0.231 | 104 |
| Cu, mg | 0.039 | 100 | 0.049 | 126 | 0.040 | 104 |

### Example 2

Coating of Linseeds with ISA and Zinc Sulphate

Linseeds were coated with 0.15% of (A), 0.225% of (B) and 0.3% of Zn (C) by using a solution containing zinc sulphate and Na salt of ISA. The recipe is shown in Table 4. A pot trial was carried out using fertilized peat (50 ppm of N, 50 ppm of P, 63 ppm of K, ammonium nitrate and monopotassium phosphate) using uncoated seeds as controls. In Table 5, percent germination, dry weight of the biomass after 14 days, nutrient analyses of the dry matter (three parallel tests with standard deviation, STD) are shown. Nutrient uptake is improved also for other elements than zinc (Table 6).

TABLE 4
Coating composition

| | ZnSO₄*7H₂O, | 34-% Na-ISA, | Water, | Zn, | N, | P, | S, |
|---|---|---|---|---|---|---|---|
| | g | g | g | g | g | g | g |
| ISA + Zn- | 14.4 | 50 | 60 | 3.3 | 0.7 | 0 | 1.6 |
| sulphate | | | | | | | |

TABLE 5
Germination and dry matter analyses of the biomass

| | | | | A | | B | | C |
|---|---|---|---|---|---|---|---|---|
| | Control, no | Control | A | 0.15% Zn, | B | 0.225% Zn, | C | 0.3% Zn, |
| | coating | STD | 0.5% Zn | STD | 0.225% Zn | STD | 0.3% Zn | STD |
| Germination, % | 94 | | 90 | | 86 | | 88 | |
| Dry weight of | 2.73 | | 2.86 | | 2.76 | | 2.86 | |
| biomass, g | | | | | | | | |
| K, % | 4.26 | 0.069 | 4.34 | 0.059 | 4.28 | 0.026 | 4.24 | 0.023 |
| P, % | 0.79 | 0.023 | 0.73 | 0.010 | 0.73 | 0.006 | 0.73 | 0.014 |
| Ca, % | 1.12 | 0.025 | 1.14 | 0.010 | 1.11 | 0.010 | 1.08 | 0.020 |
| Mg, % | 0.79 | 0.064 | 0.80 | 0.050 | 0.79 | 0.029 | 0.77 | 0.009 |
| Cl, % | 0.77 | 0.025 | 0.79 | 0.025 | 0.77 | 0.014 | 0.76 | 0.007 |
| S, % | 0.46 | 0.005 | 0.45 | 0.008 | 0.45 | 0.005 | 0.45 | 0.007 |
| Na, % | 0.26 | 0.042 | 0.30 | 0.028 | 0.27 | 0.026 | 0.29 | 0.057 |
| Si, % | 0.067 | 0.002 | 0.068 | 0.003 | 0.067 | 0.007 | 0.071 | 0.003 |
| Fe, ppm | 85 | 4.0 | 85 | 1.7 | 92 | 2.5 | 81 | 3.6 |
| Mn, ppm | 120 | 4.4 | 119 | 2.6 | 115 | 3.0 | 115 | 5.0 |
| Zn, ppm | 32 | 2.1 | 43 | 1.5 | 54 | 0.6 | 53 | 2.0 |

TABLE 6
Uptake of nutrients in comparison with a control 14 days after sowing

| | | | A | | B | | C | |
|---|---|---|---|---|---|---|---|---|
| | Control, | | 0.15% Zn, | A | 0.225% Zn, | B | 0.3% Zn, | C |
| | no coating | % | mg | % of control | mg | % of control | mg | % of control |
| Germination, % | 94 | | 90 | | 86 | | 88 | |
| Dry biomass, g | 2.73 | | 2.86 | | 2.76 | | 2.86 | |
| K, mg | 116.3 | 100 | 124.1 | 106.7 | 118.1 | 101.6 | 121.3 | 104.3 |
| P, mg | 21.6 | 100 | 20.9 | 96.8 | 20.1 | 93.4 | 20.9 | 96.8 |
| Ca, mg | 30.6 | 100 | 32.6 | 106.6 | 30.6 | 100.2 | 30.9 | 101.0 |
| Mg, mg | 21.6 | 100 | 22.9 | 106.1 | 21.8 | 101.1 | 22.0 | 102.1 |
| Cl, mg | 21.0 | 100 | 22.6 | 107.5 | 21.3 | 101.1 | 21.7 | 103.4 |
| S, mg | 12.6 | 100 | 12.9 | 102.5 | 12.4 | 98.9 | 12.9 | 102.5 |
| Na, mg | 7.1 | 100 | 8.58 | 120.9 | 7.45 | 105.0 | 8.29 | 116.8 |
| Si, mg | 1.83 | 100 | 1.95 | 106.3 | 1.85 | 101.1 | 2.03 | 111.0 |
| Fe, mg | 0.23 | 100 | 0.24 | 104.8 | 0.25 | 109.4 | 0.23 | 99.8 |
| Mn, mg | 0.33 | 100 | 0.34 | 103.9 | 0.32 | 96.9 | 0.33 | 100.4 |
| Zn, mg | 0.09 | 100 | 0.12 | 140.8 | 0.15 | 170.6 | 0.15 | 173.5 |

### Example 3

Growth of Linseeds Using the Coating Method of the Invention for Zinc Addition

During the growth period of 2002-2003, test series were carried out to compare the growth of fiber linen treated with the seed coating method of the invention with the growth of linen cultivated in a normal manner. Optimal application amount of the zinc coating of the invention was 4.5% based on the weight of the seeds. With this application amount, linen was no longer able to significantly utilize additional zinc for growth. The total amount of zinc sulphate in the coating was 5% (v/v) as pure zinc.

Symptoms caused by zinc deficiency were seen in field trials as the height of the aerial plant parts was about 10 cm. Due to zinc deficiency, linen started to produce side branches, and thus the quality of fibers was decreased. In a similar trial, linseeds were coated with zinc using the method of the invention. The coating amount was 4.5% based on the weight of the seeds. Owing to the coating, no symptoms caused by zinc deficiency were seen during initial growth of linen plants, thus avoiding the formation of side branches harmful for the quality of the fibers. Fibers formed were long and commercially suitable.

TABLE 7
Zinc uptake for fiber linen plants with a height of 10 cm from
seeds coated with zinc using the method of the invention.
Variety: Hermes ou Agatha, France.

| | Zn present (ppm) in | Zn change in |
|---|---|---|
| Treatment | the plant | the plant |
| Control | 29 | — |
| (=uncoated seed) | | |
| 3.0% Coating of the invention*, ppm | 37 | +8 |
| 4.5% Coating of the invention*, ppm | 47 | +18 |
| 6.0% Coating of the invention*, ppm | 51 | +22 |

*The coating of the invention contains 5% of pure zinc.

### Example 4

Small seed types having very low specific weights such as Poa pratensis were coated with the coating of the invention, and the activity thereof was compared to a similar iSeed treatment. In the coating of the seeds according to the invention, the seeds were coated with an ISA fixing agent containing sodium and potassium nitrate as nutrients.

iSeed treatment refers to the treatment disclosed in WO 0145498 by the same applicant, wherein the seeds are coated with a mixture of an fixing agent, potassium nitrate and monopotassium phosphate in emulsion suspension form.

In iSeed treatment, the coating was found to cover the seeds of Poa pratensis unevenly. Due to this uneven coating, the germination of the seeds was reduced, and moreover, handling of the seeds during sowing was more difficult.

On the contrary, seeds coated with the ISA fixing agent of the invention shot well, and further, the technical quality thereof was superior with respect to sowing process.

TABLE 8

| Tested item | Number of seedlings |
|---|---|
| Control | 561 ab |
| (=uncoated seed) | |
| Sodium ISA + KNO₃ | 582 b |
| iSeed-NPK | 383 a |

Comparison of pairs is performed with Tukey Test P = 0.05.

### Example 5

Comparison of the Fixing Agents of the Invention for Zinc and Phosphorus Using Corn

Corn seeds were coated with solutions containing biodegradable fixing agent, zinc sulphate and sodium phosphate (Table 9). For zinc, 0.1% of Zn, and for phosphorus, 0.225% of P were incorporated in seeds. Molar ratios of the fixing agents (Na-ISA, Na-EDDS) to zinc were 1:1. With respect to polyaspartic acid-Na, two repeating units for one zinc were used. The fixing agents Na ISA and polyaspartic acid-Na were compared using the same corn lot (146). Another corn lot (147) was used in the Na-EDDS trial. Germination test comprised 25 seeds/pot in six parallel tests. Germination, dry matter of the biomass, and nutrient uptake were analyzed in the test (Table 10). Nutrient uptake is compared with controls (=uncoated seeds) in Table 11.

The results show that germination ability remained high in all tests. Uptake of added zinc by the plants was high, and further, the uptake of other nutrients (K, P, Mg, S) and trace elements (Fe, Cu) was also improved.

Tables 10 and 11 show that the ability of different fixing agents to improve the uptake of nutrients varies, and thus ISA improves the uptake of magnesium, whereas polyaspartic acid and EDDS increase the availability of iron and copper, respectively.

TABLE 9
Coating of corn with Zn and P using different fixing agents

| | ISA | Polyaspartic acid | EDDS |
|---|---|---|---|
| Corn seeds, g | 2000 | 2000 | 2000 |
| 34-% Na-ISA, g | 30.0 | | |
| 43.5% polyaspartic acid-Na, g | | 44.4 | |
| 43.0% Na-EDDS, g | | | 26.7 |
| ZnSO₄*7H₂O, g | 8.64 | 8.64 | 8.64 |
| NaH₂PO₄*H₂O, g | 20 | 20 | 20 |
| Zn, g | 2.0 | 2.0 | 2.0 |
| P, g | 4.5 | 4.5 | 4.5 |
| S, g | 1.0 | 1.0 | 1.0 |
| N, g | 0.4 | 1.7 | 0.9 |

TABLE 10
Germination of coated corn and composition of dry
matter of the biomass 12 days after sowing
Control (=100; uncoated seeds)

| | Control | | Polyaspartic | | Control |
|---|---|---|---|---|---|
| | 146 | ISA | acid | EDDS | 147 |
| Seed lot | 146 | 146 | 146 | 147 | 147 |
| Germination, % | 99.3 | 100 | 99.3 | 100 | 100 |
| Dry matter of | 6.02 | 6.08 | 6.45 | 6.36 | 7.15 |
| biomass, g | | | | | |
| K, mg | 140 | 148 | 160 | 170 | 167 |
| P, mg | 42.9 | 46.2 | 47.5 | 43.3 | 43.2 |
| Ca, mg | 55.6 | 53.4 | 55.2 | 53.5 | 61.6 |
| Mg, mg | 32.1 | 35.8 | 37.4 | 33.3 | 37.8 |
| S, mg | 29.4 | 31.7 | 34.2 | 32.8 | 34.0 |
| Si, mg | 13.2 | 13.9 | 14.6 | 15.4 | 15.1 |
| Cl, mg | 23.6 | 21.6 | 22.3 | 25.8 | 28.1 |
| Fe, mg | 1.23 | 1.21 | 1.30 | 1.86 | 1.65 |
| Mn, mg | 0.48 | 0.45 | 0.46 | 0.41 | 0.47 |
| Zn, mg | 0.28 | 0.44 | 0.45 | 0.62 | 0.31 |
| Cu, mg | 0.05 | 0.05 | 0.05 | 0.09 | 0.10 |

TABLE 11
Uptake of nutrients compared to the
controls (=100; uncoated seeds)

| | Control | | Polyaspartic | | Control |
|---|---|---|---|---|---|
| | 146 | ISA | acid | EDDS | 147 |
| Seed lot | 146 | 146 | 146 | 147 | 147 |
| K | 100 | 106 | 115 | 102 | 100 |
| P | 100 | 108 | 111 | 100 | 100 |
| Ca | 100 | 96 | 99 | 87 | 100 |
| Mg | 100 | 111 | 116 | 88 | 100 |
| S | 100 | 108 | 116 | 96 | 100 |
| Si | 100 | 106 | 111 | 102 | 100 |
| Cl | 100 | 91 | 95 | 92 | 100 |
| Fe | 100 | 99 | 106 | 112 | 100 |
| Mn | 100 | 95 | 98 | 86 | 100 |
| Zn | 100 | 157 | 160 | 198 | 100 |
| Cu | 100 | 101 | 107 | 89 | 100 |

1. Coated plant seed, characterized in that said seed comprises a seed coated with at least one fixing agent comprising at least one asparatic acid derivative selected from the group consisting of ethylenediamine disuccinic acid, 2,2′-iminodisuccinic acid, isomers thereof and salts thereof, with and at least one plant nutrient.

2. Coated plant seed according to claim 1, characterized in that the salt of said ethylenediamine disuccinic acid, 2,2′-iminodisuccinic acid, or isomers thereof is an alkali or alkaline earth metal salt.

3. Coated plant seed according to claim 1 or 2, characterized in that said coating comprises 0.01-5%, preferably 0.03-5%, more preferably 0.1-5% by weight of the fixing agent compound, relative to seed weight

4. Coated plant seed according to claim 1, characterized in that said coating comprises 0.1-2% by weight of a trace element, relative to seed weight.

5. Coated plant seed according to claim 1, characterized in that said coating comprises 0.1-10% by weight of a nutrient salt, relative to seed weight.

6. Coated plant seed according to claim 1, characterized in that said coating further comprises 0-2% by weight of a further agent having an effect on plant growth, such as a pesticide, a growth regulator, a preservative, a stabilizer, a functionally active agent and a sugar, and further, 0.1-10% by weight of water, relative to seed weight.

7. Coated plant seed according to claim 1, characterized in that said seed is coated with an aqueous coating composition comprising 1-50%, preferably 5-50%, more preferably 5-30% by weight of the fixing agent, 0-15% by weight of a trace element, 0-70%, preferably 0-40% by weight of a nutrient salt, 0-15% by weight of a further agent having an effect on plant growth, and 30-90% by weight of water.

8. An aqueous coating composition for coating seeds, characterized in that said composition comprises at least one fixing agent comprising at least one asparatic acid derivative selected from the group consisting of ethylenediamine disuccinic acid, 2,2′-iminodisuccinic acid, isomers thereof and salts thereof, and at least one plant nutrient.

9. The aqueous coating composition according to claim 8, characterized in that said composition comprises 1-50%, preferably 5-50% by weight of the fixing agent, 0-15% by weight of a trace element, 0-70%, preferably 0-40% by weight of a nutrient salt, 0-15% by weight of a further agent having an effect on plant growth, and 30-90% by weight of water.

10. Method for coating seeds according to claim 1, characterized in that seeds to be coated are subjected in an apparatus suitable for treating seeds, followed by the addition of either
(a) an aqueous coating composition comprising at least one fixing agent compound and plant nutrient containing trace elements and/or nutrient salts, and optionally further agents having an effect on plant growth to form a coating on the surface of the seed, or
(b) at least one aqueous fixing agent compound to form an fixing agent layer on the surface of the seed, followed by the addition of a plant nutrient in powder form containing trace elements and/or nutrient salts, and optionally further agents having an effect on plant growth, to form a coating on the surface of the seed, or
(c) an aqueous coating composition comprising at least one fixing agent compound and plant nutrient to form an fixing agent layer on the surface of the seed, followed by the addition of plant nutrient in powder form containing trace elements and/or nutrient salts, and optionally further agents having an effect on plant growth, to form a coating on the surface of the seed.

11. The method according to claim 10, characterized in that the aqueous coating composition of steps a), b) and c) is the aqueous coating composition as defined in claim 8 or 9.
